(19) United States
(12) Patent Application Publication
(10) Pub. No.: US 2024/0086921 A1
(43) Pub. Date: Mar. 14, 2024

(54) PAYMENT TERMINAL PROVIDING BIOMETRIC AUTHENTICATION FOR CERTAIN CREDIT CARD TRANSACTIONS

(71) Applicant: VisionLabs B.V., Amsterdam (NL)

(72) Inventor: Anton Nazarkin, Moscow (RU)

(73) Assignee: VisionLabs B.V., Amsterdam (NL)

(21) Appl. No.: 18/331,081

(22) Filed: Jun. 7, 2023

Related U.S. Application Data
(63) Continuation of application No. 17/374,082, filed on Jul. 13, 2021, now abandoned.

(30) Foreign Application Priority Data
Dec. 18, 2020 (RU) 2020141919
Dec. 18, 2020 (RU) 2020141924
Dec. 18, 2020 (RU) 2020141936

(51) Int. Cl. G06Q 20/40; G06Q 20/20; G06V 40/16; G06V 40/40

(52) U.S. Cl. CPC G06Q 20/40145; G06Q 20/204; G06V 40/172; G06V 40/45

(57) ABSTRACT

The techniques described herein relate to methods and apparatus for authenticating credit card transactions using a payment terminal that leverages a facial recognition module to capture facial images. The payment terminal communicates with a back-end server to perform the facial recognition process, and determines whether to authorize or deny a transaction based on the results of the facial recognition process received from the back-end server.

### RELATED APPLICATIONS

This application claims priority to Russian Application Serial No. 2020141919, filed Dec. 18, 2020; Russian Application Serial No. 2020141924, filed Dec. 18, 2020; and priority to Russian Application Serial No. 2020141936, filed Dec. 18, 2020, each of which is incorporated herein by reference in its entirety.

### FIELD

This application relates generally to a payment terminal and computing devices that provide for authenticating credit card payments with biometric authentication, and in particular using facial recognition.

### BACKGROUND

Credit card transactions are one of the most popular consumer payment methods. As a result, consumers have a number of different methods by which they can pay via credit card. Consumers can use physical credit cards, which can be read using a magnetic strip and/or a chip on the credit card. Consumers can also use electronic payment methods, such as using credit card “wallets” on smartphones, such that consumers to pay by credit card without needing to carry around a physical credit card. Some credit card payment methods, including electronic methods, also offer contactless payment. With the ever-increasing popularity of credit card transactions, appropriate security for such transactions needs to similarly scale to provide for secure credit card transactions.

### SUMMARY

According to one aspect, a computerized method is provided for execution by a payment terminal. The payment terminal includes at least one processor and memory configured to store instructions that, when executed by the at least one processor, cause the at least one processor to receive credit card data for use with a credit card transaction, capture, using an imaging device of the payment terminal, image data of at least a portion of a face of a user operating the payment terminal, and authenticate the user to use the credit card data using remote facial recognition. Authenticating the user includes transmitting the image data and credit card information to a remote computing device, such that the remote computing device can perform the remote facial recognition of the user, receiving, from the remote computing device, authentication data indicative of whether the user is authenticated to use the credit card data based on the remote facial recognition, and determining whether to complete the credit card transaction based on the received authentication data.

According to one aspect, a portable payment terminal is provided that includes a battery, a first docking interface sized to connect to a second docking interface of a base when the payment terminal is docked in the base to charge the battery and to communicate with an external device, a wireless communication module, an imaging device configured to capture image data of at least a portion of a face of a user operating the payment terminal, and at least one processor in communication with the imaging device and memory. The at least one processor is configured to execute instructions stored in the memory that cause the at least one processor to receive credit card data for use with a credit card transaction, and communicate, via the wireless communication module, with a remote computing device to perform remote facial recognition to authenticate the user to use the credit card data based on the image data.

According to one aspect, a computerized method is provided for execution by at least one processor and memory configured to store instructions that, when executed by the at least one processor, cause the at least one processor to receive, from a payment terminal, credit card data for use with a credit card transaction and image data of at least a portion of a face of a user operating the payment terminal. The instructions further cause the at least one processor to generate, using the image data, a first facial descriptor for the face of the user, wherein the first facial descriptor comprises a first numeric array, access, from a database, a second facial descriptor associated with the credit card data, wherein the second facial descriptor comprises a second numeric array, determine whether the user is authorized to use the credit card data by determining whether the first facial descriptor matches the second facial descriptor, and transmit, to the payment terminal, data indicative of whether the user is authorized to use the credit card data based on whether the first facial descriptor matches the second facial descriptor.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should be further appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF THE DRAWINGS

Various aspects and embodiments will be described herein with reference to the following figures. It should be appreciated that the figures are not necessarily drawn to scale. Items appearing in multiple figures are indicated by the same or a similar reference number in all the figures in which they appear.

FIG. 1 is a diagram of an exemplary system for providing credit card payments using facial recognition, according to some embodiments.

FIGS. 2A-2G show an exemplary embodiment of a portable payment terminal, according to some embodiments.

FIG. 3 is a flow chart showing a computerized method for using facial recognition to authenticate credit card transactions above a threshold amount, according to some embodiments.

FIG. 4 is a flow chart showing an exemplary computerized method for a payment terminal to communicate with a remote computing device to authenticate a credit card transaction using facial recognition, according to some embodiments.

FIG. 5 is a flow chart of an exemplary computerized method of selecting subsets of the image data for use with the facial recognition process, according to some embodiments.

FIG. 6 is a diagram showing an exemplary set of three images that can be processed to determine a best image, according to some embodiments.

FIG. 7 is a diagram showing an exemplary facial tracking process across a set of images, according to some embodiments.

FIG. 8 is a diagram showing an exemplary facial alignment, according to some embodiments.

FIG. 9 is a flow chart showing an exemplary computerized method of a remote computing device performing aspects of a facial recognition process, according to some embodiments.

FIG. 10 shows an exemplary facial descriptor, according to some embodiments.

FIG. 11 is an exemplary block diagram of an example computer system that may be used to implement embodiments of the technology described herein.

### DETAILED DESCRIPTION

The inventors have discovered and appreciated that conventional credit card systems and transactions do not provide for sufficient payment security. Credit cards can be lost or stolen, and electronic credit card information can likewise be stolen. As a result, credit card fraud is becoming more and more widespread with the continued increasing use of credit card transactions. While some credit card transactions require entry of a personal identification number to complete the transaction, not all transactions require pins, and pins can likewise be stolen. Further, having to enter a pin can be a cumbersome additional step for users. It is therefore desirable to provide easier and more robust authentication techniques, which are not offered by conventional payment terminals.

To address the above-described shortcomings of conventional systems, the techniques described herein provide a payment terminal that combines credit card payment and/or other loyalty program payment functionality with biometric authentication using facial recognition technology. When a payment process is started, the payment terminal captures images of the user and coordinates with back-end compute resources to perform a liveness check and/or facial recognition to authenticate the user for the credit card transaction. The liveness check and/or aspects of facial recognition can be performed either locally at the payment terminal and/or remotely by the back-end compute resources. The techniques provide such authentication in a quick and secure manner. The techniques can be integrated into a payment terminal that supports all the existing forms of payment, including cards with magnet stripes, contactless payment methods and NFC payment methods. The payment terminal can further be embodied in a portable payment terminal that can be used in both docked and undocked scenarios. Therefore, the techniques can provide a payment terminal that integrates facial authentication as primary and/or additional factor of verification for any type of credit card transaction easily into most credit card payment set-ups.

In some embodiments, the payment terminal can be configured so that the payment terminal does not store or manage sensitive information, such as facial images, data extracted from the images (e.g., facial descriptors), and/or other types of personal data. In some embodiments, the payment terminal can be configured to send a facial descriptor to a remote computing device for biometric processing. Due to the inability to reverse-engineer a facial descriptor into the original image, transmitting facial descriptors can avoid transmitting images of people.

As described herein, the payment terminal can be configured for mobile use, and can be used in docked and/or undocked configurations. As a result, the payment terminal can include different wired and/or wireless communication functionality. In some embodiments, the payment terminal can include one or more interfaces that are designed to provide a plurality of different communication protocols (e.g., separate from and/or in addition to interface(s) used to provide power to the device). In some embodiments, the interface can provide USB, Ethernet and RS232 communication over a single interface. Such a multi-protocol interface can allow for a smaller form factor of the payment terminal, compared to having separate interfaces for each communication protocol. As a result, the payment terminal includes sufficient functionality so that the payment terminal can fully replace conventional payment terminals that do not support biometrics without requiring sacrifices to the device form factor. As a result, the payment terminal can be easily integrated into existing systems (e.g., CRM systems, point of sale (POS) systems, payment authorization systems, and/or the like), and can be managed by the cashier from the cash desk.

Although a particular exemplary embodiment of the present payment terminal will be described further herein, other alternate embodiments of all components related to the present device are interchangeable to suit different applications. Turning to the figures, specific non-limiting embodiments of payment terminals and corresponding methods are described in further detail. It should be understood that the various systems, components, features, and methods described relative to these embodiments may be used either individually and/or in any desired combination as the disclosure is not limited to only the specific embodiments described herein.

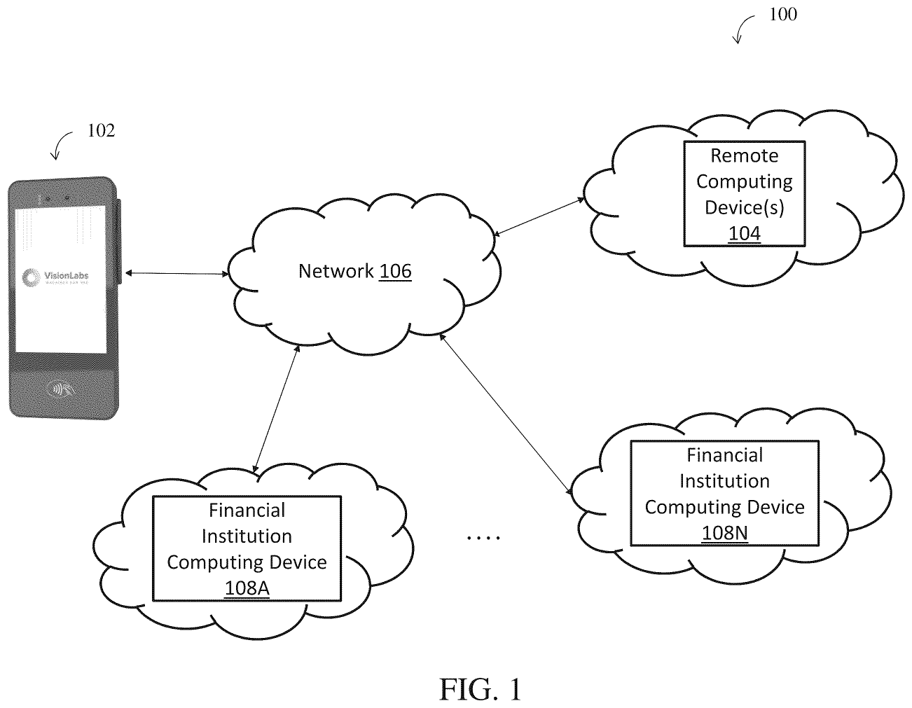

The payment terminal is configured to communicate with one or more remote computing devices that perform the biometric authentication process, such as a back-end facial recognition server. FIG. 1 is a diagram of an exemplary system 100 for providing credit card payments using facial recognition, according to some embodiments. The system 100 includes a payment terminal 102 that is in communication with one or more remote computing devices 104 through network 106. As described herein, in some embodiments the payment terminal 102 is configured to process credit card transactions. The payment terminal 102 includes sensors, such as imaging sensor(s) and/or depth sensor(s), that capture data used to perform a facial recognition process. Aspects of the facial recognition process can be performed by the payment terminal 102 and/or the one or more remote computing devices 104, such as performing liveness checks, generating facial descriptors using images captured of the payment terminal operator, and/or the like. The one or more remote computing devices 104 are in communication with various financial institutions through their respective computing devices 108A through 108N (collectively referred to as financial information computing device 108). The one or more remote computing devices 104 determine which financial institution is associated with the credit card information being used for the transaction, and obtains a facial descriptor associated with the credit card information from the appropriate financial information computing device 108. The one or more remote computing devices 104 compare the facial descriptor generated for the user of the payment terminal 102 with the obtained facial descriptor to determine whether to authenticate the user to use the credit card for the transaction.

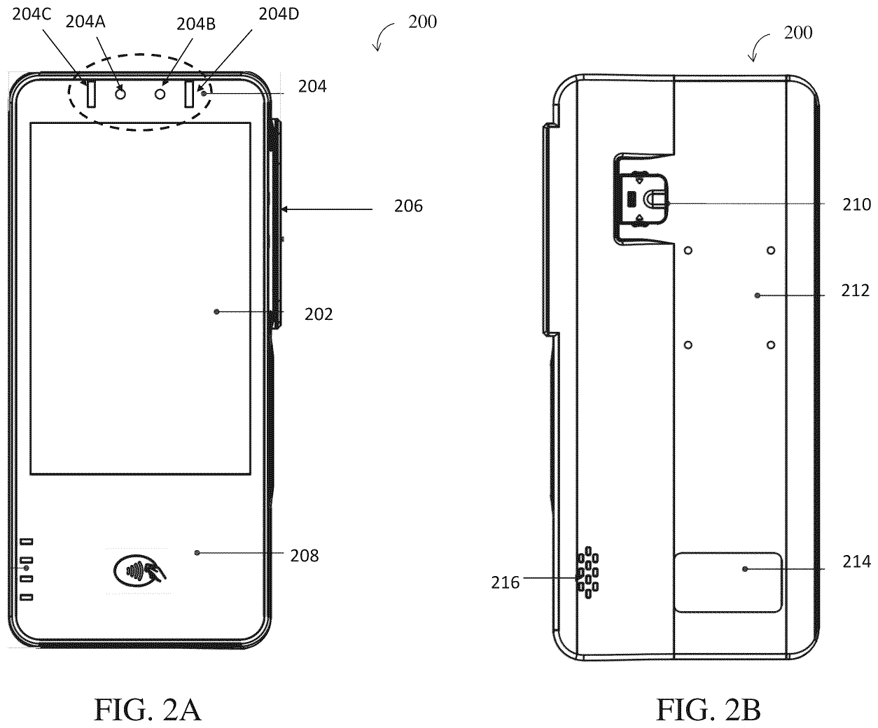

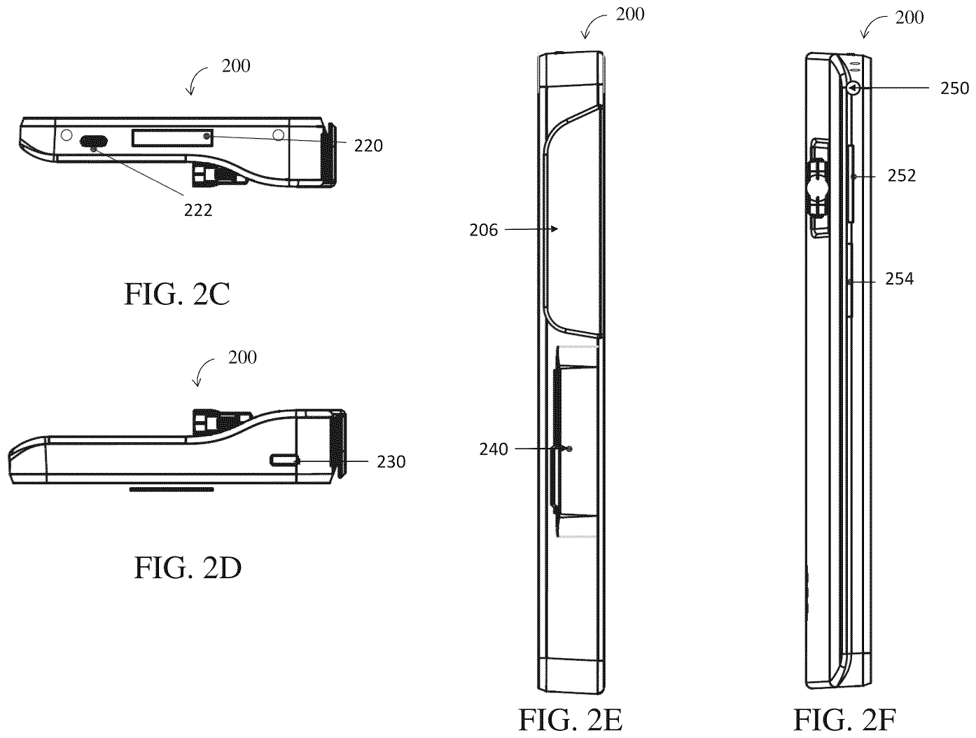

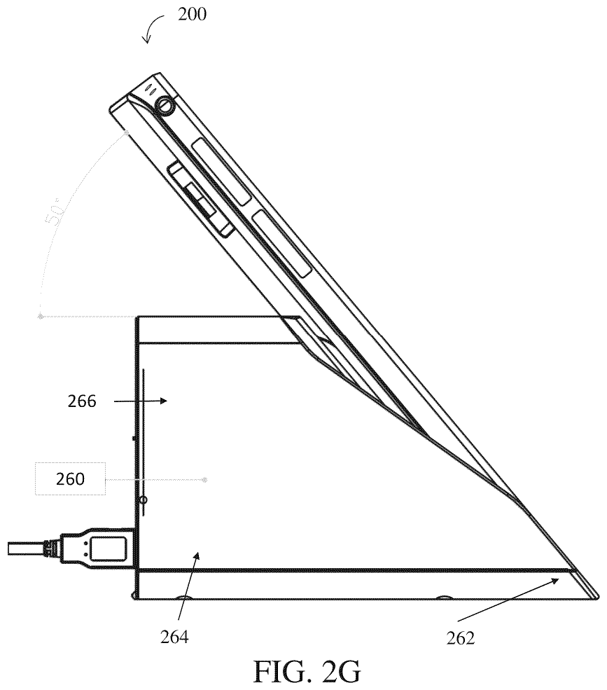

FIGS. 2A-2G show an exemplary embodiment of a portable payment terminal 202, according to some embodiments. While FIGS. 2A-2G show an exemplary configuration of the portable payment terminal, it should be appreciated that these examples are intended to be illustrative only and not limiting, as various other configurations can be used in accordance with the techniques described herein. It should be appreciated that the payment terminal 202 can also include various components inside of the component housing that are not visible in FIGS. 2A-2G. For example, the payment terminal 202 can include a battery (not shown), which allows the payment terminal 202 to operate in an undocked configuration as described further herein. The payment terminal 202 can also include at least one processor and memory (also not shown) that stores instructions that the processor is configured to execute to perform aspects of the techniques described herein. It should also be appreciated that while not shown, the payment terminal 202 also includes various circuitry, wiring, and/or the like to interface the various components of the payment terminal 202 that are described herein.

In some embodiments, the payment terminal 200 also includes a wireless communication module (not shown). The wireless communication module can provide wireless communication protocols, such as cellular communication protocols, Bluetooth communication protocols, WiFi communication protocols, and/or a combination of communication protocols. The payment terminal 200 can include a second wireless communication module. For example, the second wireless communication module can be configured to execute a wireless communication protocol to read the credit card data from a credit card (e.g., via a contactless reader, NFC, etc., as described herein).

FIG. 2A is a diagram of a front view of the portable payment terminal 200. The payment terminal 200 includes a screen 202. The screen 202 can be of any appropriate size, such as a six inch display (a fifteen centimeter display), a seven inch display (an eighteen centimeter display), an eight inch display (a twenty centimeter display), etc. While not shown, the payment terminal 200 can also include a passive infrared (PIR) sensor for managing the brightness of the screen 202. The payment terminal 202 includes a facial recognition module 204. The facial recognition module 204 can include a single imaging device and/or a plurality of imaging devices. For example, the facial recognition module 204 can include a single, dual and/or multi-sensor configuration. The sensors can include imaging devices (e.g., cameras, RGB sensor(s)), NIR sensor(s), DEPTH sensor(s), TOF sensor(s) and/or the like. In the example of FIG. 2A, the facial recognition module 204 includes two imaging devices 204A and 204B (e.g., which can include transparent covers, such as transparent glass covers) configured to capture a set of images of at least a portion of a face of a user operating the payment terminal 202. The facial recognition module 204 also includes two LEDs 204C and 204D in this example, including a regular LED and a NIR LED. The facial recognition module 204 may also include a depth sensor configured to generate a second set of images of at least a portion of the user's face (e.g., for a liveness check). In some embodiments, the payment terminal can use a NIR camera. The NIR camera can be implemented using imaging device(s) 204A/204B in conjunction with a NIR light source such as the NIR LED 204D. In some embodiments, the payment terminal includes further sensing devices for performing the liveness check (e.g., dedicated NIR sensors, depth sensors, etc.), which can also be located in the facial recognition module 204.

The payment terminal 202 includes a side slot 206 configured to receive a credit card and the payment terminal 202 includes requisite hardware and/or software to read the credit card data from the credit card once inserted. In some embodiments, the side slot is a secure magstripe reader (MSR). In some embodiments, the side slot is configured to read data from a chip on the credit card. The payment terminal 202 also includes a contactless credit card reader 208 (e.g., as provided by VISA or MASTERCARD). In some embodiments, the payment terminal can support NFC communications to facilitate payments with smart devices that support NFC technology.

FIG. 2B is a diagram of a back view of the portable payment terminal 200. As shown in FIG. 2B, the payment terminal 200 includes a multi-protocol interface 210 that provides an ethernet interface (e.g., 10base-T, 100base-T, 1000base-T, etc.), a USB interface (e.g., USB 1.0, USB 2.0, USB TYPE-C), and/or an RS232 interface. The payment terminal 200 includes a location 212 for connecting to a mount/holder (e.g., shown as four screw holes). The payment terminal 200 includes a speaker 216. In some embodiments, the payment terminal can also include a microphone (not shown). An optional name plate 214 can be included as well.

FIG. 2C is a diagram of a bottom view of the portable payment terminal 200. As shown in FIG. 2C, the portable payment terminal 200 includes a docking interface 220. The docking interface 220 is sized to connect to a mating interface disposed on a base when the payment terminal 220 is docked to the base. In some embodiments, the docking interface 220 can be a female interface and the corresponding mating interface on the base can be a male interface, but the techniques are not so limited. The payment terminal 200 can be docked, for example, to charge the battery, to communicate with an external device, and/or the like. In some embodiments, the portable payment terminal 200 can provide one or more communication interfaces, such as a USB interface, a RS232 interface, and/or the like. The payment terminal 200 also includes interface 222. Interface 222 can provide a power interface to charge the battery, a communication interface, and/or the like. For example, interface 222 can provide a second USB interface on the bottom of the payment terminal 200 (e.g., for use if the payment terminal is not in the dock).

FIG. 2D shows a top view of the payment terminal 200, which includes a power on/off switch 230. FIG. 2E shows a view of the right side of the payment terminal 200, including the side slot 206 and also card reader 240. In some embodiments, card reader 240 is a Europay, MasterCard, and Visa (EMV) card reader. FIG. 2F shows a view of the left side of the payment terminal 200, which includes an ear set jack 250, a first slot 252, and a second slot 254. The first slot 252 can be a slot used to receive a security-related card, such as a Secure Access Module (SAM) card. In some embodiments, the slot 252 can be used to receive a memory card, such as a TF card. In some embodiments, the second slot 254 can be a slot for receiving a card related to a communication protocol. For example, the second slot 254 can be configured to receive a Subscriber Identification Module (SIM) card.

FIG. 2G shows an example of the payment terminal 200 docked in a base 260. While not visible, the base 260 includes a mating interface disposed around area 262 that connects with the docking interface 220 of payment terminal 200. The base 260 also includes an interface 264. The interface 264 can provide power and/or a communication protocol. For example, the communication protocol can be USB, RS232, and/or the like. In some embodiments, the interface 264 can provide complementary features as those provided by the docking interface 220. For example, both the docking interface 220 and the interface 264 can provide power, USB and RS232 (e.g., such that the payment terminal 200 can physically connect to both power and communicate with a remote device when docked). The base 260 can include other features, such as a printer disposed at area 266.

It should be appreciated that the payment terminal can include necessary hardware and/or software as described herein so that the payment terminal can be configured for operation according to various configurations and/or modes. In some embodiments, the payment terminal can be used with a dock station. For example, it may be desirable to businesses (e.g., small and/or medium businesses) that do not want to use and/or do not have advanced cashier desks (e.g., that can interface directly with the payment terminal) to use the payment terminal with the docking station. In some embodiments, the payment terminal can be used without a docking station. For example, it may be desirable for stores, such as large chain stores, to use undocked payment terminals (e.g., where mounts or racks are used to secure the payment terminals for use).

It should be appreciated that various communication protocols can be used to perform the credit card transactions described herein. For example, some stores may connect the payment terminals to the network using a local area network (LAN) (e.g., a cable network), and therefore such stores may not use WiFi and/or cellular communication protocols. As another example, some stores may prefer to use wireless communication functionality of the payment terminal, and may instead opt to use WiFi and/or cellular communication protocols in lieu of networked protocols. As a further example, the payment terminal can connect to peripheral devices, such as a cash drawer, using RS232 and/or other physical communication protocols. As an additional example, the payment terminal can use USB to connect to a point of sale (POS) terminal of a cashier to exchange data. As another example, Bluetooth can be used to receive data, such as data for a courier order. As a result, the payment terminal can include a custom interface (e.g., multi-protocol interface 210, docking interface 220 and/or interface 222) that can provide power to the device, facilitate communication with the payment terminal via Ethernet, to connect to the payment terminal like a cashier's computer, and/or some combination thereof. As a result, the payment terminal can provide a custom interface that allows connection of a single cable that can provide power, USB, Ethernet and RS232 interfaces. Otherwise, needing to support separate interfaces for each on the payment terminal would result in a much larger unit (e.g., requiring further design implications than those required to support other features, such as magstripe readers).

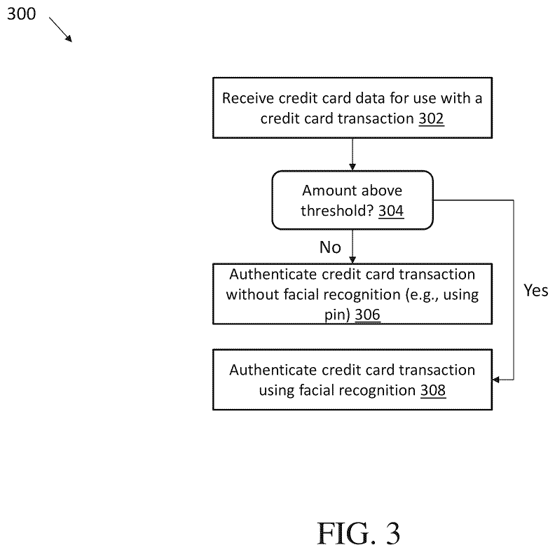

As a general matter, the portable payment terminal is configured to authenticate credit card transactions using biometric authentication. According to some embodiments, the portable payment terminal can use facial recognition for some and/or all credit card transactions. In some embodiments, the payment terminal can be configured to use facial recognition for credit card transactions that meet one or more thresholds. FIG. 3 is a flow chart showing a computerized method 300 using facial recognition to authenticate credit card transactions above a threshold amount, according to some embodiments. At step 302, the payment terminal receives credit card data for use with a credit card transaction. As described herein, the payment terminal can receive credit card data in various manners. In some embodiments, the payment terminal can read the credit card data from a credit card inserted into a side slot of the payment terminal (e.g., side slot 206). In some embodiments, the payment terminal can read the credit card data from a credit card using a wireless communication protocol (e.g., NFC, contactless payment, etc.). In some embodiments, payment terminal can read the credit card data from an electronic device. For example, the payment terminal can read the credit card data from a mobile device e-wallet (e.g., using Apple Pay, Samsung Pay, etc.). In some embodiments, payment terminal can receive virtual credit card data.

At step 304, the payment terminal determines whether the amount of the transaction is above a threshold. The threshold amount can be, for example, a dollar amount (e.g., five dollars/euro, ten dollars/euro, twenty dollars/euro, and/or the like). In some embodiments, the threshold can be a number of transactions (e.g., for the person, at a store, and/or the like). For example, the threshold can be whether the credit card transaction is the first transaction at a particular store. As another example, face authentication may be initiated after a certain number of failed/unsuccessful numbers of attempts to use a credit card (e.g., one attempt, two attempts, three attempts, etc.). As a further example, the threshold can be based on certain age thresholds (e.g., fifteen, sixteen, twenty-one years old), such as those that require a minimum age to purchase the product (e.g., alcohol, cigarettes, guns, etc.). As an additional example, face authentication may be used when applying a certain amount of credit (e.g., any credit, credit over five dollars, credit over ten dollars, etc.), such as coupons, a personalized discount from a financial organization to a named customer (e.g., including rewards at a particular store or chain of stores), etc.

If the transaction is not above the threshold, the method moves to step 306 and authenticates the credit card transaction without using facial recognition. In some embodiments, the payment terminal can complete the transaction without further authentication. In some embodiments, the payment terminal can authenticate the credit card transaction by requiring the user to enter a Personal Identification Number (PIN) to complete the credit card transaction. If the transaction is above the threshold, the method moves to step 308 and authenticates the credit card transaction using facial recognition. In some embodiments, upon determining the amount exceeds the predetermined threshold, the user does not need to enter a PIN to complete the credit card transaction.

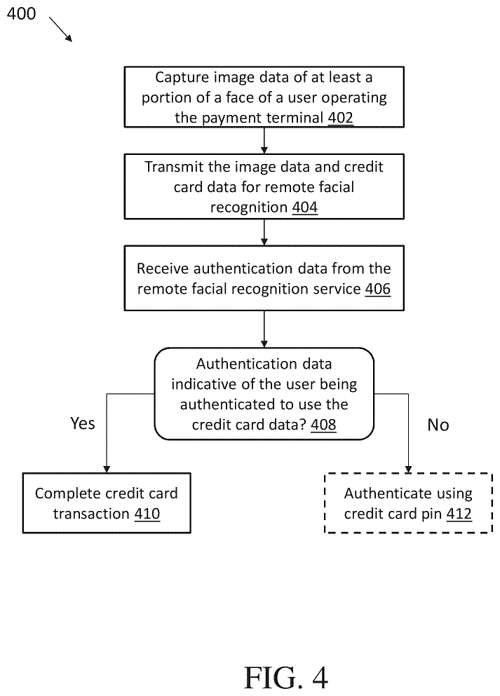

The payment terminal can perform facial recognition by performing aspects of the process locally and/or remotely. FIG. 4 is a flow chart showing an exemplary computerized method 400 for authenticating a credit card transaction using facial recognition. At step 402, the payment terminal captures, using an imaging device of the payment terminal, image data of at least a portion of a face of a user operating the payment terminal. As described herein, the payment terminal can include one or more imaging devices, including image sensors configured to generate a first set of images, a depth sensor configured to generate a second set of the images, and/or the like.

In some embodiments, as shown in FIG. 4, the payment terminal communicates with a remote computing device to authenticate a user using remote facial recognition. At step 404, the payment terminal transmits the image data and credit card information to a remote computing device (e.g., remote computing device(s) 104) so that the remote computing device can perform one or more parts of the remote facial recognition process of the user. In some embodiments, the payment terminal sends the image data itself, pre-processed image data, and/or the actual data used to perform the facial recognition (e.g., a facial descriptor) to the remote computing device. Therefore, the payment terminal and/or the remote computing device can therefore perform one or more of the steps of the facial descriptor generation process, depending on the system configuration. For example, in some configurations the payment terminal sends unprocessed image data to the remote computing device, and the remote computing device processes the image data as necessary to perform the facial recognition. As another example, in some configurations, the payment terminal performs some and/or all of the image processing required for the process, and/or generates the ultimate data used to perform facial recognition (e.g., the facial descriptor) and transmits the generated data to the remote computing device.

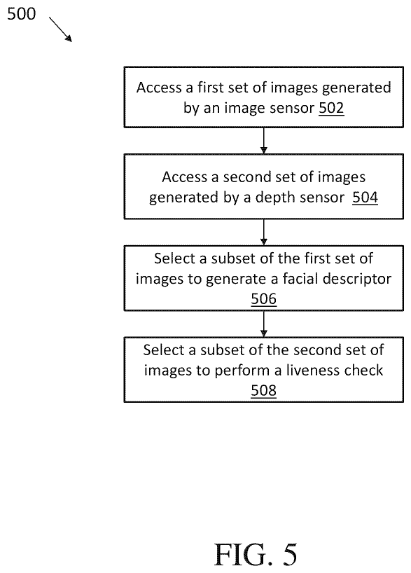

FIG. 5 is a flow chart of an exemplary computerized method 500 of selecting subsets of the image data for use with the facial recognition process, according to some embodiments. At step 502, the payment terminal receives a first set of images generated by an image sensor (e.g., which are used for facial recognition). At step 504, the payment terminal receives a second set of images generated by a depth sensor (e.g., which are used for a liveness check). At step 506, the payment terminal selects a subset of the first set of images to use to generate the first facial descriptor. For example, a facial descriptor extraction operation can include a number of different steps. The extraction operation can include, for example, various image processing steps, such as performing face detection in the image(s) (e.g., in an image or a live video sequence, real-time video capture by the device), warping the detected face, facial alignment to compensate affine angles and center the face, and/or image tracking. The extraction operation can then extract the descriptor using the processed image data.

According to some embodiments, the techniques can include performing parameter estimation to determine whether to use images for facial recognition and/or to determine parameters used for generating the facial descriptor. The parameter estimation can include analyzing one or more of image quality, eye status, head pose, eyeglasses detection, gaze detection, mouth status, a suitability analysis of the image, and/or the like. The image quality analysis can include evaluating the quality of the image (e.g., a normalized image) for sufficient further processing, such as evaluating whether the image is blurred, underexposed, overexposed, has low saturation, has inhomogeneous illumination, has an appropriate specularity level, and/or the like. The output can be, for example, a score value (e.g., a value from 0 to 1 where 1 is the norm and 0 is the maximum value of quality parameter). The eye status analysis can include, for example, determining an eye status (closed, open, occluded), an iris position (e.g., using one or more landmarks for each eye), an eyelid position (e.g., using one or more landmarks for each eye), and/or the like based on the input image (e.g., a normalized image).

The head pose analysis can include determining the roll, pitch and/or yaw angle values for the head pose. The head pose can be determined based on input landmarks and/or based on the source image (e.g., using a trained CNN model). The eyeglasses detection can return the probability of whether no glasses are present on the face in an image (e.g., a normalized image), whether prescription glasses are present on face, whether sunglasses are present on the face, whether a facial covering and/or mask is present on the face, and/or the like. The result for each analysis can include a score value. In some embodiments, the payment terminal can, upon detection of an item on the face (e.g., sunglasses and/or a facial covering), prompt for removal of the item in order to re-acquire images of the person's face. The gaze detection analysis can include determining (e.g., based on facial landmarks) one or more of a pitch (e.g., an angle of gaze vertical deviation in degrees) and a yaw (e.g., an angle of gaze horizontal deviation in degrees). The mouth status processing can include, for example, determining data indicative of whether the mouth is open, occluded, smiling, and/or the like. The suitability analysis can evaluate whether the obtained face image can be used for face recognition (e.g., prior to extracting a facial descriptor. The output can be a score ranging from a low-end indicative of a bad quality image to a high end with a best quality image, and can be performed based on face detection data (e.g., face box data).

In some embodiments, the techniques can perform a facial detection process on the images to identify the face (e.g., by providing a box around the face), to identify facial landmarks, data indicative of detecting a face (e.g., a facial score), and/or the like. According to some embodiments, the techniques can perform facial detection using a CNN-based algorithm to detect all faces in each frame/image. Facial landmarks can be calculated for, for example, facial alignment and/or for performing additional estimations. Key points can be used to represent detected facial landmarks. The techniques can generate any number of key points for the facial landmarks, such as five key points (e.g., two for eyes, one for nose tip and two for mouth edges), ten key points, fifty key points, and/or any number of landmarks based on the desired level of detail for each face.

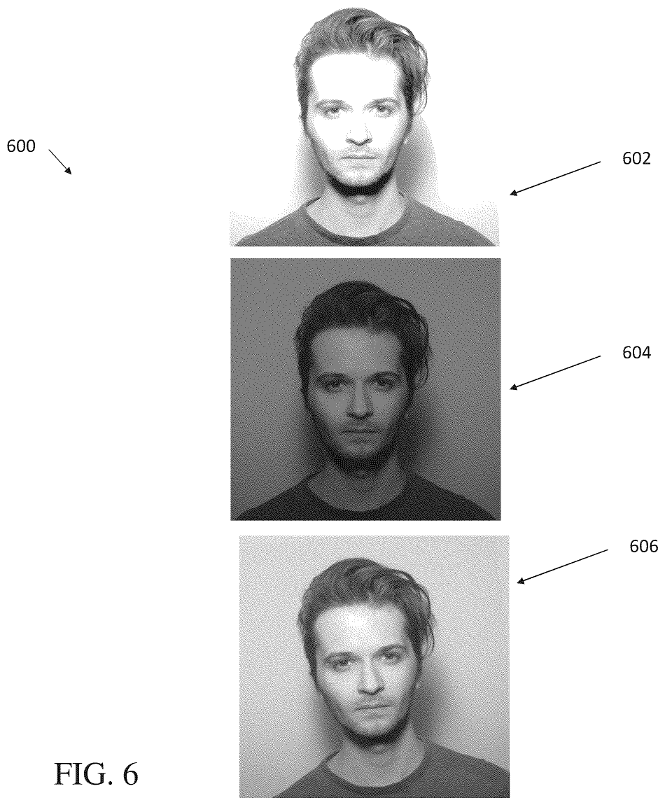

In some embodiments, the techniques can include determining one or more best images and/or shot(s) of a user's face. For example, a best shot can be selected (e.g., by default) based on a facial detection score in order to select the best candidate images for further processing. According to some embodiments, the techniques can leverage a comparative method to choose the best shot based on a function class that allows comparison of the received facial detections to selecting the most appropriate image and/or a number of images for aggregated face descriptor extraction. FIG. 6 is a diagram showing an exemplary set of three images 602-606, as an illustrative example. The system can compare the scores for the images 602-606 to determine that image 606 is a best shot compared to the other two images 602 and 604. As a result, best shot techniques can allow the system to identify the face images that are most suitable for facial recognition from a sequence of images or frames. Since each frame has its own ID, the techniques can continuously update the set of best shots to specify which images will be used for the facial recognition phase. While FIG. 6 shows just three images 602-606, it should be appreciated that any number of images can be processed when determining a best shot (e.g., five images, ten images, twenty images, etc.).

The payment terminal and/or the remote computing device can perform real-time facial monitoring, including using facial landmarks, eye/mouth status, gaze, head pose, and/or the like. In some embodiments, the techniques can process an incoming data flow of images containing faces, which can be sorted according to the detector score results, including tracking and re-detect functions. It should be appreciated that the face recognition process can be configured so that the payment device is not continuously capturing images all the time. For example, the face recognition process can be initiated only after the face payment sequence is engaged by the user, by the cashier, and/or the like.

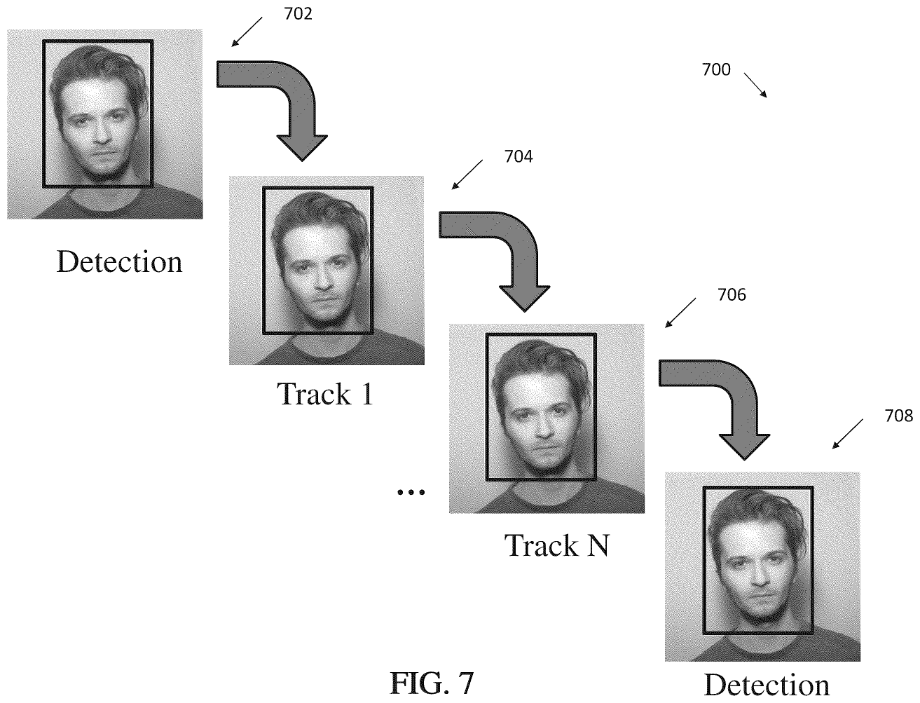

In some embodiments, the techniques can include performing facial tracking across images (e.g., image and/or video frames). The techniques can include detection and estimation functions to estimate faces. FIG. 7 is a diagram showing an exemplary facial tracking process across a set of images, according to some embodiments. The computing device performs an initial face detection in image 702. The detected face is then tracked across subsequent images. In some examples, a detected face is re-detected across several frames (e.g., in an area (FOV, ROI) after an initial detection event. The computing device re-detects the face in image 704 for the first step of the tracking. The tracking process continues across a number of images, including through the nth step of tracking, illustrated at image 706. The computing device then completes the tracking and detection process at image 708. In some embodiments, if a face was not re-detected in a subsequent image of the series, the tracking process can be interrupted (e.g., such that the payment terminal continues to look for faces in other frames while the facial recognition process is running). In some embodiments, the payment terminal may interrupt/cancel the face payment operation if the payment terminal did not detect necessary pre-defined parameters (e.g., size, angles, quality) in a certain period of time since the process was initiated, a face simply disappeared, a face is not present in the camera view, and/or the like. Otherwise, if the face continues to be detected, the tracking can continue across further subsequent images. Frames can be processed one-by-one, with each frame having a unique identifier. This can allow, for example, identification of the frames associated with a tracked face. The system can use the results to determine which facial shots are used for face recognition (e.g., until reaching a sufficient number of frames, such as 10 frames, 20 frames, 50 frames, etc.).

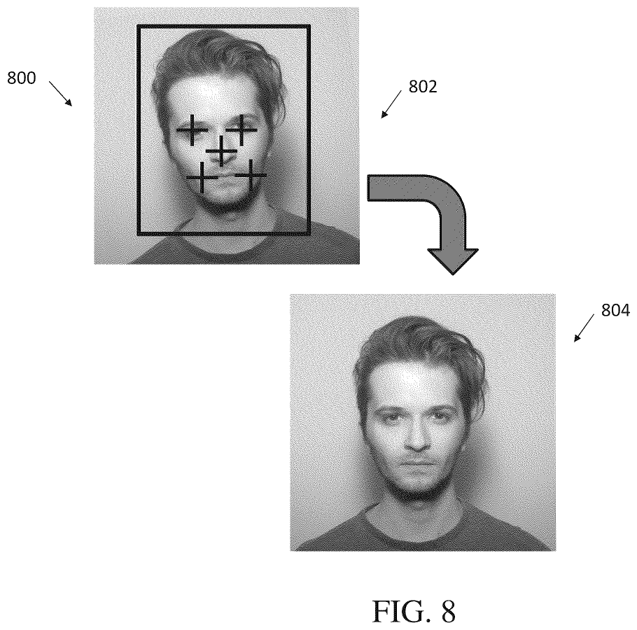

In some embodiments, the techniques can include modifying one or more aspects of the image and/or facial data, such as dimensions and/or poses. For example, the computing device can perform a facial alignment process to ensure a face is aligned across images in a desired manner (e.g., along a vertical axis, etc.). FIG. 8 is a diagram 800 showing an example of facial alignment, according to some embodiments. As shown by image 802, the data used for alignment can include pre-processed data, such as facial detection boxes and/or facial landmarks. The techniques can perform various image processing steps based on the input data to generate the aligned image 804. In some embodiments, the system can perform a warping process (e.g., normalization, planarization). The process can include performing one or more of: compensation of rotation of the image plane, image centering based on eye localization, image cropping, and/or the like.

As described herein, the payment terminal can generate the facial descriptor (e.g., which can also be referred to using various other terms, such as a face template, a biometric template, etc., such that the term “facial descriptor” is not intended to be limiting) locally and/or the facial descriptor can be generated by the remote computing device. To perform the actual extraction, the techniques can include processing the image along with additional data (e.g., the detection result with the box of the detected face, facial landmarks, and/or the like) to determine the facial descriptor. The facial descriptor can be generated using, for example, a trained machine learning model, such as trained CNNs. In some embodiments, a plurality of CNNs can be used. For example, different CNN versions can be used for different considerations, such as for distinct characteristics in speed (of extraction), size and accuracy (completeness) of face template/descriptor, and/or the like. As another example, different CNNs can generate different size descriptors. For example, sizes can include 128 bytes, 256 bytes, 512 bytes, 1024 bytes, and/or the like.

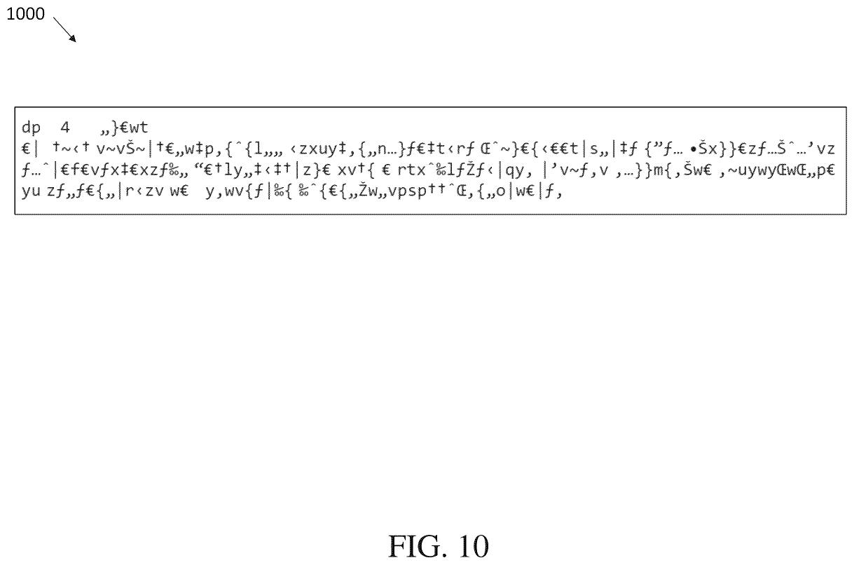

The face descriptor itself can be a set of object parameters that are specially encoded. The face descriptors can be generated such that the descriptors are more or less invariant to various affine object transformations, color variations, and/or the like. Being invariant to such transformations, the techniques can provide for efficient use of such sets to identify, lookup, and compare real-world objects such as faces. In some embodiments, the facial descriptors include numeric arrays of alphanumeric and/or special characters. FIG. 10 is a diagram of an exemplary facial descriptor 1000, according to some embodiments. Advantageously, as shown in FIG. 10, since the facial descriptor is generated using appropriate algorithmic techniques (e.g., CNNs), it is not possible to reverse-engineer the original image from the descriptor.

At step 508, the computing device (e.g., the payment terminal and/or remote computing device) selects a subset of the second set of images to analyze to perform a liveness check. The liveness check can include determining whether a live person was captured (e.g., as compared to a still image being used to try and trick or bypass the authentication process). As described herein, image data from NIR sensors, depth sensors, TOF sensors, and/or the like, can be used to check liveness. The payment terminal can perform the liveness check offline locally and/or send the selected subset to the remote computing device to perform the liveness check. For example, images captured using a depth sensor can be processed to determine whether a live person is using the payment terminal. As described herein, any sensors in the facial recognition module can be used, such as RGB sensors, NIR sensors, depth sensors, etc. for the liveness check. In some embodiments, certain techniques may be preferred, such as NIR sensors and/or depth sensors, which may be more reliable and non-cooperative (e.g., does not require any action from the user), such as due to NIR sensors providing range (e.g., distance to face) information. The data used for the liveness check can be an image sequence that includes a sequence of frames of a video stream from an imaging device and/or a video file. According to some embodiments, when processing a time series of frames, the techniques can require that a user appears in front of the relevant sensor(s) until the calculated probability of the person being a live person (e.g., calculated by neural network models) will reach a predetermined threshold. As a result, the liveness check can be used in combination with facial recognition to ensure that a live person is using the credit card, which can provide further security for the credit card transaction process.

At step 406, the payment terminal receives, from the remote computing device, authentication data indicative of whether the user is authenticated to use the credit card data based on the remote facial recognition. At step 408, the payment terminal determines whether to complete the credit card transaction based on the received authentication data. If the authentication data indicates that the user is authenticated to use the credit card, the method proceeds to step 410 and completes the credit card transaction. If the authentication data indicates that the user is not authenticated to use the credit card, the payment terminal can terminate the transaction and/or perform other authentication techniques. For example, the payment terminal can optionally execute step 412 to authenticate the transaction using a PIN by prompting, via the display of the payment terminal, the user to enter a credit card PIN associated with the credit card data to complete the transaction.

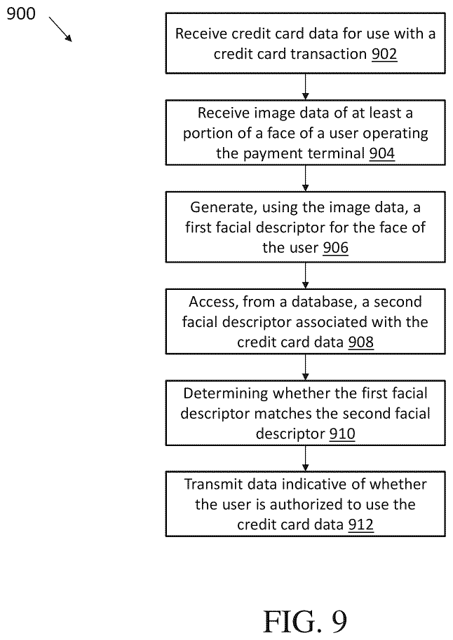

As described herein, the remote computing device is configured to process the data received from the payment terminal to perform the facial recognition process. FIG. 9 is a flow chart showing an exemplary computerized method 900 for a computing device (remote from the payment terminal) to perform aspects of the facial recognition process, according to some embodiments. At step 902, the computing device (e.g., the remote computing device(s) 104) receives, from the payment terminal, the credit card data for use with a credit card transaction (e.g., the credit card number and/or the like). At step 904, the computing device receives image data of at least a portion of a face of a user operating the payment terminal. While steps 902 and 904 are shown as separate steps, this is for exemplary purposes only, and it should be appreciated that the data can be received in a single communication and/or any number of communications, as necessary.

At step 906, the computing device generates, using the image data, a first facial descriptor for the face of the user. As described herein, the facial descriptor generation process can include various steps, including parameter estimation, facial detection, tracking, alignment, and generation of the facial descriptor. The computing device can be configured to perform some and/or all of the facial descriptor generation process, as described in conjunction with FIG. 4.

At step 908, the computing device accesses, from a database, a second facial descriptor associated with the credit card data. The second facial descriptor can be of a same format as the first facial descriptor. For example, like the first facial descriptor, the second facial descriptor can also include a second numeric array. The computing device can access the second facial descriptor from the database by requesting the second facial descriptor from a remote bank database of a bank associated with the credit card data and/or other institution that provides the credit card account.

At step 910, the computing device determines whether the user is authorized to use the credit card data by determining whether the first facial descriptor matches the second facial descriptor. According to some embodiments, the computing device can perform a descriptor matching process on the first facial descriptor and the second facial descriptor to generate a similarity score indicative of a similarity between the first facial descriptor and the second facial descriptor. The computing device can then use the similarity score to determine whether the facial descriptors sufficiently match. For example, the computing device can determine whether the similarity score is above a predetermined threshold.

As described herein, face descriptors include data representing a set of features that describe the face (e.g., in a manner that takes into account face transformation, size, and/or other parameters). Face descriptor matching can be performed in a manner that allows the computing device to determine with a certain probability whether two face descriptors belong to the same person. The descriptors can be compared to determine a similarity score. The similarity score value can be a normalized range of values. For example, the value can range from 0-1. Other output data can be generated, such as a Euclidian distance between the vectors of face descriptors.

In some embodiments, the system can determine whether the similarity score is above a desired threshold. For example, the similarity score is selected by the Bank/Service provider. The higher the minimum similarity threshold is set, the lower the chance of using an erroneous match. For example, a match of 95%, 90%, 80% and/or the like can be of sufficient confidence to proceed with authorizing the credit card transaction. However, a match below such a percentage can be insufficient to authenticate the user for the transaction.

The computing device can determine whether the user is authorized to use the credit card data based on whether the first facial descriptor matching the second facial descriptor at step 910. At step 912, the computing device transmits, to the payment terminal, data indicative of whether the user is authorized to use the credit card data. If the facial descriptors match, the computing device can transmit data indicative of the user being authorized to use the credit card data. In some embodiments, the computing device can transmit other information determined during the matching process to the payment terminal, such as the similarity score, etc.

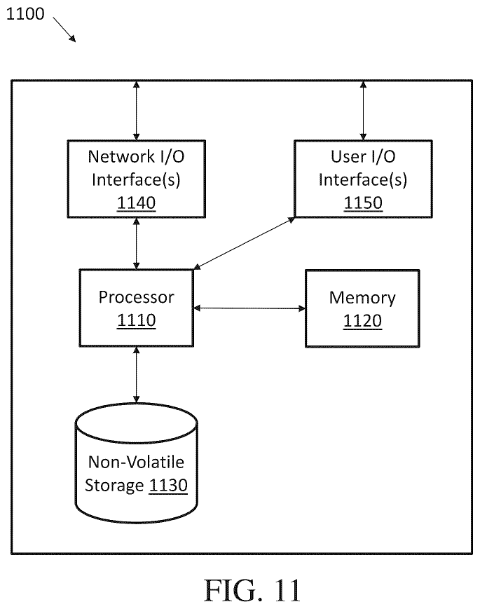

The techniques described herein can be incorporated into various types of circuits and/or computing devices. FIG. 11 shows a block diagram of an example computer system 1100 that may be used to implement embodiments of the technology described herein. For example, the computer system 1100 can be embodied in the payment terminal, the remote computing device(s) that are used to perform facial recognition, and/or the like. The computing device 1100 may include one or more computer hardware processors 1102 and non-transitory computer-readable storage media (e.g., memory 1104 and one or more non-volatile storage devices 1106). The processor(s) 1102 may control writing data to and reading data from (1) the memory 1104; and (2) the non-volatile storage device(s) 1106. To perform any of the functionality described herein, the processor(s) 1102 may execute one or more processor-executable instructions stored in one or more non-transitory computer-readable storage media (e.g., the memory 1104), which may serve as non-transitory computer-readable storage media storing processor-executable instructions for execution by the processor(s) 1102.

The terms “program” or “software” are used herein in a generic sense to refer to any type of computer code or set of processor-executable instructions that can be employed to program a computer or other processor (physical or virtual) to implement various aspects of embodiments as discussed above. Additionally, according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform tasks or implement abstract data types. Typically, the functionality of the program modules may be combined (e.g., centralized) or distributed.

Various inventive concepts may be embodied as one or more processes, of which examples have been provided. The acts performed as part of each process may be ordered in any suitable way. Thus, embodiments may be constructed in which acts are performed in an order different than illustrated, which may include performing some acts simultaneously, even though shown as sequential acts in illustrative embodiments.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

Various aspects are described in this disclosure, which include, but are not limited to, the following aspects:
1. A computerized method for execution by a payment terminal comprising at least one processor and memory configured to store instructions that, when executed by the at least one processor, cause the at least one processor to:
   receive credit card data for use with a credit card transaction;
   capture, using an imaging device of the payment terminal, image data of at least a portion of a face of a user operating the payment terminal; and
   authenticate the user to use the credit card data using remote facial recognition, comprising:
      transmitting the image data and credit card information to a remote computing device, such that the remote computing device can perform the remote facial recognition of the user;
      receiving, from the remote computing device, authentication data indicative of whether the user is authenticated to use the credit card data based on the remote facial recognition; and
      determining whether to complete the credit card transaction based on the received authentication data.
2. The method of 1, wherein receiving the credit card data comprises reading the credit card data from a credit card inserted into a side slot of the payment terminal.
3. The method of any of 1-2, wherein receiving the credit card data comprises:
   reading the credit card data from a credit card using a wireless communication protocol;
   reading the credit card data from an electronic device;
   receiving virtual credit card data; or some combination thereof.
4. The method of any of 1-3, wherein the instructions are further configured to cause the at least one processor to:
   determine whether an amount of the credit card transaction exceeds a predetermined threshold;
   upon determining the amount exceeds the predetermined threshold, performing the step of authenticating the user to use the credit card data using the remote facial recognition, such that the user does not need to enter a Personal Identification Number (PIN) to complete the credit card transaction.
5. The method of 4, wherein the instructions are further configured to cause the at least one processor to, upon determining the amount does not exceed the predetermined threshold, upon determining the authentication data is indicative of the user not being authenticated to use the credit card data, or both:
   prompting, via a display of the payment terminal, the user to enter a credit card Personal Identification Number (PIN) associated with the credit card data to complete the transaction.
6. The method of any of 1-5, wherein the instructions are further configured to cause the at least one processor to:
   capture, using a depth sensor of the payment terminal, second image data; and
   determine, based on the second image data, an indication of whether the second image data captures a live person.
7. A payment terminal comprising:
   an imaging device configured to capture image data of at least a portion of a face of a user operating the payment terminal;
   at least one processor in communication with the imaging device and memory, the at least one processor being configured to execute instructions stored in the memory that cause the at least one processor to:
   receive credit card data for use with a credit card transaction; and
   authenticate the user to use the credit card data using remote facial recognition, comprising:
      transmitting the image data and credit card information to a remote computing device, such that the remote computing device can perform the remote facial recognition of the user;
      receive, from the remote computing device, authentication data indicative of whether the user is authenticated to use the credit card data based on the remote facial recognition; and
      determine whether to complete the credit card transaction based on the received authentication data.
8. The payment terminal of 7, wherein the imaging device comprises:
   an image sensor configured to generate a first image of the image data; and
   a depth sensor configured to generate a second image of the image data.
9. The payment terminal of any of 7-8, further comprising a side slot configured to receive a credit card, wherein receiving the credit card data comprises reading the credit card data from the credit card inserted into the side slot.
10. The payment terminal of any of 7-9, further comprising a wireless communication module configured to execute a wireless communication protocol to read the credit card data from a credit card, an electronic device, or both.
11. The payment terminal of any of 7-10, wherein the instructions are further configured to cause the at least one processor to:
   determine whether an amount of the credit card transaction exceeds a predetermined threshold;
   upon determining the amount exceeds the predetermined threshold, the at least one processor is configured to perform the step of authenticating the user to use the credit card data using the remote facial recognition.
12. The payment terminal of 11, wherein:
   the payment terminal further comprises a display; and
   the instructions are further configured to cause the at least one processor to, upon determining the amount does not exceed the predetermined threshold:
      prompt, via the display of the payment terminal, the user to enter a pin associated with the credit card data to complete the transaction.
13. The payment terminal of any of 7-12, wherein transmitting the image data to the remote computing device comprises:
   generating a facial descriptor, comprising detecting a face in the image data and performing a descriptor extraction process on the detected face to generate the facial descriptor; and
   transmitting the facial descriptor to the remote computing device.
14. A non-transitory computer-readable media comprising instructions that, when executed by one or more processors on a payment terminal, are operable to cause the one or more processors to:
   receive credit card data for use with a credit card transaction;
   capture, using an imaging device of the payment terminal, image data of at least a portion of a face of a user operating the payment terminal; and
   authenticate the user to use the credit card data using remote facial recognition, comprising:
      transmitting the image data and credit card information to a remote computing device, such that the remote computing device can perform the remote facial recognition of the user;
      receiving, from the remote computing device, authentication data indicative of whether the user is authenticated to use the credit card data based on the remote facial recognition; and
      determining whether to complete the credit card transaction based on the received authentication data.
15. The non-transitory computer-readable media of 14, wherein receiving the credit card data comprises reading the credit card data from a credit card inserted into a side slot of the payment terminal.
16. The non-transitory computer-readable media of any of 14-15, wherein receiving the credit card data comprises:
   reading the credit card data from a credit card using a wireless communication protocol;
   reading the credit card data from an electronic device;
   receiving virtual credit card data; or some combination thereof.
17. The non-transitory computer-readable media of any of 14-16, wherein the instructions are further configured to cause the one or more processors to:
   determine whether an amount of the credit card transaction exceeds a predetermined threshold;
   upon determining the amount exceeds the predetermined threshold, performing the step of authenticating the user to use the credit card data using the remote facial recognition, such that the user does not need to enter a Personal Identification Number (PIN) to complete the credit card transaction.
18. The non-transitory computer-readable media of 17, wherein the instructions are further configured to cause the one or more processors to, upon determining the amount does not exceed the predetermined threshold, upon determining the authentication data is indicative of the user not being authenticated to use the credit card data, or both:
   prompting, via a display of the payment terminal, the user to enter a credit card Personal Identification Number (PIN) associated with the credit card data to complete the transaction.
19. The non-transitory computer-readable media of any of 14-18, wherein the instructions are further configured to cause the one or more processors to:
   capture, using a depth sensor of the payment terminal, second image data; and
   determine, based on the second image data, an indication of whether the second image data captures a live person.
20. A portable payment terminal comprising:
   a battery;
   a first docking interface sized to connect to a second docking interface of a base when the payment terminal is docked in the base to charge the battery and to communicate with an external device;
   a wireless communication module;
   an imaging device configured to capture image data of at least a portion of a face of a user operating the payment terminal; and
   at least one processor in communication with the imaging device and memory, the at least one processor being configured to execute instructions stored in the memory that cause the at least one processor to:
      receive credit card data for use with a credit card transaction; and
      communicate, via the wireless communication module, with a remote computing device to perform remote facial recognition to authenticate the user to use the credit card data based on the image data.
21. The portable payment terminal of 20, wherein the first docking interface comprises a female interface.
22. The portable payment terminal of any of 20-21, wherein communicating with the remote computing device to perform the remote facial recognition comprises:
   transmitting, via the wireless communication module, the image data and credit card information to the remote computing device, such that the remote computing device can perform the remote facial recognition of the user; and
   receive, from the remote computing device, authentication data indicative of whether the user is authenticated to use the credit card data based on the facial recognition.
23. The portable payment terminal of 22, wherein transmitting the image data to the remote computing device comprises:
   generating a facial descriptor, comprising detecting a face in the image data and performing a descriptor extraction process on the detected face to generate the facial descriptor; and
   transmitting the facial descriptor to the remote computing device.
24. The portable payment terminal of any of 20-23, wherein the wireless communication module comprises one or more of:
   a cellular communication module;
   a WiFi communication module; and
   a Bluetooth communication module.
25. The portable payment terminal of any of 20-24, further comprising a flatscreen display in communication with the one or more processors.
26. The portable payment terminal of any of 20-25, further comprising a combined interface providing an Ethernet interface, a USB interface, and a RS232 interface, in communication with the one or more processors.
27. The portable payment terminal of any of 20-26, further comprising a side slot configured to receive a credit card, wherein receiving the credit card data comprises reading the credit card data from the credit card inserted into the side slot.
28. The portable payment terminal of any of 20-27, further comprising a second wireless communication module configured to execute a wireless communication protocol to read the credit card data from a credit card.
29. The portable payment terminal of any of 20-28, further comprising a speaker in communication with the one or more processors.
30. The portable payment terminal of any of 20-29,
   wherein the imaging device comprises:
      an image sensor configured to generate a first set of images of the image data; and
      a depth sensor configured to generate a second set of images of the image data; and
   the at least one processor is configured to execute instructions stored in the memory that cause the at least one processor to:
      select a subset of the first set of images for facial recognition; and
      select a subset of the second set of images to analyze to determine whether a live person was captured.
31. A computerized method for execution by at least one processor and memory configured to store instructions that, when executed by the at least one processor, cause the at least one processor to:
   receive, from a payment terminal:
      credit card data for use with a credit card transaction; and
      image data of at least a portion of a face of a user operating the payment terminal;
   generate, using the image data, a first facial descriptor for the face of the user, wherein the first facial descriptor comprises a first numeric array;
   access, from a database, a second facial descriptor associated with the credit card data, wherein the second facial descriptor comprises a second numeric array;
   determine whether the user is authorized to use the credit card data by determining whether the first facial descriptor matches the second facial descriptor; and
   transmit, to the payment terminal, data indicative of whether the user is authorized to use the credit card data based on whether the first facial descriptor matches the second facial descriptor.
32. The method of 31, wherein:
   determining whether the user is authorized to use the credit card data comprises determining the user is not authorized to use the credit card data based on to the first facial descriptor not matching the second facial descriptor; and
   transmitting the data indicative of whether the user is authorized to use the credit card data comprises transmitting data indicative of the user not being authorized to use the credit card data.
33. The method of any of 31-32, wherein:
   determining whether the user is authorized to use the credit card data comprises determining the user is authorized to use the credit card data based on the first facial descriptor matching the second facial descriptor; and
   transmitting the data indicative of whether the user is authorized to use the credit card data comprises transmitting data indicative of the user being authorized to use the credit card data.
34. The method of any of 31-33, further comprising determining the first facial descriptor matches the second facial descriptor by:
   performing a descriptor matching process on the first facial descriptor and the second facial descriptor to generate a similarity score indicative of a similarity between the first facial descriptor and the second facial descriptor; and
   determining the similarity score is above a predetermined threshold.
35. The method of any of 31-34, wherein accessing the second facial descriptor from the database comprises requesting the second facial descriptor from a remote bank database of a bank associated with the credit card data.
36. The method of any of 31-35, wherein:
   receiving the image data comprises:
      receiving a first set of images generated by an image sensor; and
      receiving a second set of images generated by a depth sensor; and
   the instructions further cause the at least one processor to:
      select a subset of the first set of images to generate the first facial descriptor; and
      select a subset of the second set of images to analyze to determine whether a live person was captured.
37. A non-transitory computer-readable media comprising instructions that, when executed by one or more processors on a computing device, are operable to cause the one or more processors to:
   receive, from a payment terminal:
      credit card data for use with a credit card transaction; and
      image data of at least a portion of a face of a user operating the payment terminal;
   generate, using the image data, a first facial descriptor for the face of the user, wherein the first facial descriptor comprises a first numeric array;
   access, from a database, a second facial descriptor associated with the credit card data, wherein the second facial descriptor comprises a second numeric array;
   determine whether the user is authorized to use the credit card data by determining whether the first facial descriptor matches the second facial descriptor; and
   transmit, to the payment terminal, data indicative of whether the user is authorized to use the credit card data based on whether the first facial descriptor matches the second facial descriptor.
38. The non-transitory computer-readable media of 37, wherein:
   determining whether the user is authorized to use the credit card data comprises determining the user is not authorized to use the credit card data based on to the first facial descriptor not matching the second facial descriptor; and
   transmitting the data indicative of whether the user is authorized to use the credit card data comprises transmitting data indicative of the user not being authorized to use the credit card data.
39. The non-transitory computer-readable media of any of 37-38, wherein:
   determining whether the user is authorized to use the credit card data comprises determining the user is authorized to use the credit card data based on the first facial descriptor matching the second facial descriptor; and
   transmitting the data indicative of whether the user is authorized to use the credit card data comprises transmitting data indicative of the user being authorized to use the credit card data.
40. The non-transitory computer-readable media of 39, wherein the instructions are further configured to cause the one or more processors to determine the first facial descriptor matches the second facial descriptor by:
   performing a descriptor matching process on the first facial descriptor and the second facial descriptor to generate a similarity score indicative of a similarity between the first facial descriptor and the second facial descriptor; and
   determining the similarity score is above a predetermined threshold.
41. The non-transitory computer-readable media of any of 37-40, wherein accessing the second facial descriptor from the database comprises requesting the second facial descriptor from a remote bank database of a bank associated with the credit card data.
42. The non-transitory computer-readable media of any of 37-41, wherein:
   receiving the image data comprises:
      receiving a first set of images generated by an image sensor; and
      receiving a second set of images generated by a depth sensor; and
   the instructions further cause the at least one processor to:
      select a subset of the first set of images to generate the first facial descriptor; and
      select a subset of the second set of images to analyze to determine whether a live person was captured.
43. A system comprising a memory storing instructions, and one or more processors configured to execute the instructions to:
   receive, from a payment terminal:
      credit card data for use with a credit card transaction; and
      image data of at least a portion of a face of a user operating the payment terminal;
   generate, using the image data, a first facial descriptor for the face of the user, wherein the first facial descriptor comprises a first numeric array;
   access, from a database, a second facial descriptor associated with the credit card data, wherein the second facial descriptor comprises a second numeric array;
   determine whether the user is authorized to use the credit card data by determining whether the first facial descriptor matches the second facial descriptor; and
   transmit, to the payment terminal, data indicative of whether the user is authorized to use the credit card data based on whether the first facial descriptor matches the second facial descriptor.
44. The system of 43, wherein:
   determining whether the user is authorized to use the credit card data comprises determining the user is not authorized to use the credit card data based on to the first facial descriptor not matching the second facial descriptor; and
   transmitting the data indicative of whether the user is authorized to use the credit card data comprises transmitting data indicative of the user not being authorized to use the credit card data.
45. The system of any of 43-44, wherein:
   determining whether the user is authorized to use the credit card data comprises determining the user is authorized to use the credit card data based on the first facial descriptor matching the second facial descriptor; and
   transmitting the data indicative of whether the user is authorized to use the credit card data comprises transmitting data indicative of the user being authorized to use the credit card data.
46. The system of 45, wherein the instructions are further configured to cause the one or more processors to determine the first facial descriptor matches the second facial descriptor by:
   performing a descriptor matching process on the first facial descriptor and the second facial descriptor to generate a similarity score indicative of a similarity between the first facial descriptor and the second facial descriptor; and
   determining the similarity score is above a predetermined threshold.
47. The system of any of 43-46, wherein accessing the second facial descriptor from the database comprises requesting the second facial descriptor from a remote bank database of a bank associated with the credit card data.
48. The system of any of 43-47, wherein:
   receiving the image data comprises:
      receiving a first set of images generated by an image sensor; and
      receiving a second set of images generated by a depth sensor; and
   the instructions further cause the at least one processor to:
      select a subset of the first set of images to generate the first facial descriptor; and
      select a subset of the second set of images to analyze to determine whether a live person was captured.

What is claimed is:

1. A computerized method for execution by at least one processor and memory configured to store instructions that, when executed by the at least one processor, cause the at least one processor to:
receive, from a payment terminal configured to read data from a credit card and/or electronic device:
credit card data for use with a credit card transaction, wherein the credit card data was read from the credit card and/or the electronic device by the payment terminal; and
image data of at least a portion of a face of a user operating the payment terminal;
generate, using the image data, a first facial descriptor for the face of the user by processing the image data with a model, wherein the first facial descriptor comprises a first numeric array;
access, from a database associated with the credit card data, a second facial descriptor associated with the credit card data by requesting the second facial descriptor, wherein the second facial descriptor comprises a second numeric array;
determine whether the user is authorized to use the credit card data by determining whether the first facial descriptor matches the second facial descriptor; and
transmit, to the payment terminal, data indicative of whether the user is authorized to use the credit card data based on whether the first facial descriptor matches the second facial descriptor to allow the payment terminal to determine whether to complete the credit card transaction.

2. The method of claim 1, wherein:
determining whether the user is authorized to use the credit card data comprises determining the user is not authorized to use the credit card data based on the first facial descriptor not matching the second facial descriptor; and
transmitting the data indicative of whether the user is authorized to use the credit card data comprises transmitting data indicative of the user not being authorized to use the credit card data.

3. The method of claim 1, wherein:
determining whether the user is authorized to use the credit card data comprises determining the user is authorized to use the credit card data based on the first facial descriptor matching the second facial descriptor; and
transmitting the data indicative of whether the user is authorized to use the credit card data comprises transmitting data indicative of the user being authorized to use the credit card data.

4. The method of claim 3, further comprising determining the first facial descriptor matches the second facial descriptor by:
performing a descriptor matching process on the first facial descriptor and the second facial descriptor to generate a similarity score indicative of a similarity between the first facial descriptor and the second facial descriptor; and
determining the similarity score is above a predetermined threshold.

5. The method of claim 1, wherein accessing the second facial descriptor from the database comprises requesting the second facial descriptor from a remote bank database of a bank associated with the credit card data.

6. The method of claim 1, wherein:
receiving the image data comprises:
receiving a first set of images generated by an image sensor; and
receiving a second set of images generated by a depth sensor; and
the instructions further cause the at least one processor to:
select a subset of the first set of images to generate the first facial descriptor; and
select a subset of the second set of images to analyze to determine whether a live person was captured.

7. A non-transitory computer-readable media comprising instructions that, when executed by one or more processors on a computing device, are operable to cause the one or more processors to:
receive, from a payment terminal configured to read data from a credit card and/or electronic device:
credit card data for use with a credit card transaction, wherein the credit card data was read from the credit card and/or the electronic device by the payment terminal; and
image data of at least a portion of a face of a user operating the payment terminal;
generate, using the image data, a first facial descriptor for the face of the user by processing the image data with a model, wherein the first facial descriptor comprises a first numeric array;
access, from a database associated with the credit card data, a second facial descriptor associated with the credit card data by requesting the second facial descriptor, wherein the second facial descriptor comprises a second numeric array;
determine whether the user is authorized to use the credit card data by determining whether the first facial descriptor matches the second facial descriptor; and
transmit, to the payment terminal, data indicative of whether the user is authorized to use the credit card data based on whether the first facial descriptor matches the second facial descriptor to allow the payment terminal to determine whether to complete the credit card transaction.

8. The non-transitory computer-readable media of claim 7, wherein:
determining whether the user is authorized to use the credit card data comprises determining the user is not authorized to use the credit card data based on the first facial descriptor not matching the second facial descriptor; and
transmitting the data indicative of whether the user is authorized to use the credit card data comprises transmitting data indicative of the user not being authorized to use the credit card data.

9. The non-transitory computer-readable media of claim 7, wherein:
determining whether the user is authorized to use the credit card data comprises determining the user is authorized to use the credit card data based on the first facial descriptor matching the second facial descriptor; and
transmitting the data indicative of whether the user is authorized to use the credit card data comprises transmitting data indicative of the user being authorized to use the credit card data.

10. The non-transitory computer-readable media of claim 9, wherein the instructions are further configured to cause the one or more processors to determine the first facial descriptor matches the second facial descriptor by:
performing a descriptor matching process on the first facial descriptor and the second facial descriptor to generate a similarity score indicative of a similarity between the first facial descriptor and the second facial descriptor; and
determining the similarity score is above a predetermined threshold.

11. The non-transitory computer-readable media of claim 7, wherein accessing the second facial descriptor from the database comprises requesting the second facial descriptor from a remote bank database of a bank associated with the credit card data.

12. The non-transitory computer-readable media of claim 7, wherein:
receiving the image data comprises:
receiving a first set of images generated by an image sensor; and
receiving a second set of images generated by a depth sensor; and
the instructions further cause the one or more processors to:
select a subset of the first set of images to generate the first facial descriptor; and
select a subset of the second set of images to analyze to determine whether a live person was captured.

13. A system comprising a memory storing instructions, and one or more processors configured to execute the instructions to:
receive, from a payment terminal configured to read data from a credit card and/or electronic device:
credit card data for use with a credit card transaction, wherein the credit card data was read from the credit card and/or the electronic device by the payment terminal; and
image data of at least a portion of a face of a user operating the payment terminal;
generate, using the image data, a first facial descriptor for the face of the user by processing the image data with a model, wherein the first facial descriptor comprises a first numeric array;
access, from a database associated with the credit card data, a second facial descriptor associated with the credit card data by requesting the second facial descriptor, wherein the second facial descriptor comprises a second numeric array;
determine whether the user is authorized to use the credit card data by determining whether the first facial descriptor matches the second facial descriptor; and
transmit, to the payment terminal, data indicative of whether the user is authorized to use the credit card data based on whether the first facial descriptor matches the second facial descriptor to allow the payment terminal to determine whether to complete the credit card transaction.

14. The system of claim 13, wherein:
determining whether the user is authorized to use the credit card data comprises determining the user is not authorized to use the credit card data based on the first facial descriptor not matching the second facial descriptor; and
transmitting the data indicative of whether the user is authorized to use the credit card data comprises transmitting data indicative of the user not being authorized to use the credit card data.

15. The system of claim 13, wherein:
determining whether the user is authorized to use the credit card data comprises determining the user is authorized to use the credit card data based on the first facial descriptor matching the second facial descriptor; and
transmitting the data indicative of whether the user is authorized to use the credit card data comprises transmitting data indicative of the user being authorized to use the credit card data.

16. The system of claim 15, wherein the instructions are further configured to cause the one or more processors to determine the first facial descriptor matches the second facial descriptor by:
performing a descriptor matching process on the first facial descriptor and the second facial descriptor to generate a similarity score indicative of a similarity between the first facial descriptor and the second facial descriptor; and
determining the similarity score is above a predetermined threshold.

17. The system of claim 13, wherein accessing the second facial descriptor from the database comprises requesting the second facial descriptor from a remote bank database of a bank associated with the credit card data.

18. The system of claim 13, wherein:
receiving the image data comprises:
receiving a first set of images generated by an image sensor; and
receiving a second set of images generated by a depth sensor; and
the instructions further cause the one or more processors to:
select a subset of the first set of images to generate the first facial descriptor; and
select a subset of the second set of images to analyze to determine whether a live person was captured.

19. The method of claim 1, wherein the credit card data comprises a credit card number.
